(19) United States
(12) Patent Application Publication
(10) Pub. No.: US 2025/0267438 A1
(43) Pub. Date: Aug. 21, 2025

(54) COORDINATED SNIFFING OF AIR TRAFFIC WITHIN A GROUP OF AUDIO OUTPUT DEVICES

(71) Applicant: Google LLC, Mountain View, CA (US)

(72) Inventor: Peter T. Liu, Sunnyvale, CA (US)

(73) Assignee: Google LLC, Mountain View, CA (US)

(21) Appl. No.: 19/102,618

(22) PCT Filed: Aug. 17, 2023
(86) PCT No.: PCT/US2023/072371

§ 371 Date: Feb. 10, 2025

Related U.S. Application Data
(60) Provisional application No. 63/398,795, filed on Aug. 17, 2022.

(51) Int. Cl. H04W 4/80; H04L 5/00; H04R 1/10

(52) U.S. Cl. CPC H04W 4/80; H04L 5/0055; H04R 1/1041; H04R 2420/07

(57) ABSTRACT

Various arrangements for coordinated sniffing of air traffic by sink devices are described herein. The coordinated sniffing can involve one sink device (e.g., a true wireless earbud) sniffing on the air traffic intended for the other earbud without awareness or coordination from the source device. Such sniffing is transparent to the source device and the source device needs to take no action. The arrangements detailed herein have a primary mode of coordination that does not require a direct link between the earbuds nor direct coordination. The arrangement detailed herein further can include algorithms/techniques to cause the source to retransmit packets regardless of whether the packets were received successfully/unsuccessfully by the receiving earbud and/or the sniffing earbud.

### CROSS REFERENCES TO RELATED APPLICATIONS

This Application claims priority to U.S. Provisional Patent Application No. 63/398,798, entitled “Coordinated Sniffing of Air Traffic within a Group of Audio Output Devices,” filed on Aug. 17, 2022, the entire disclosure of which is hereby incorporated by reference for all purposes.

### BACKGROUND

In Bluetooth LE Audio, each sink device in an isochronous group, whether Connected Isochronous Group (CIG) or Broadcast Isochronous Stream (BIG), receives a dedicated stream that in many configurations contains only audio for one particular channel. For example, a left earbud receives only left audio, and a right earbud receives only right audio. However, in some examples such as for spatial audio, both left and right audio is needed by each earbud to render output audio appropriately.

### SUMMARY

Various embodiments for coordinated sniffing of air traffic by sink devices are described herein. The coordinated sniffing can involve one sink device (e.g., a true wireless stereo earbud) sniffing on the air traffic intended for the other earbud without awareness or coordination from the source device. Such sniffing is transparent to the source device and the source device needs to take no action. The arrangements detailed herein have a primary mode of coordination that does not require a direct link between the earbuds nor direct coordination. The arrangement detailed herein further can include algorithms/techniques to cause the source to retransmit packets regardless of whether the packets were received successfully/unsuccessfully by the receiving earbud and/or the sniffing earbud. In some embodiments, a method for coordinated sniffing of packets is described. The method may comprise receiving, by a first sink device, a downstream audio packet addressed to the first sink device. The method may comprise attempting to sniff, by a second sink device, the downstream audio packet addressed to the first sink device. The method may comprise causing data to be transmitted to an audio source device, wherein the transmission of the data is timed to cause the audio source device to resend the downstream audio packet to the first sink device. The method may comprise transmitting, by the audio source device, a resend of the downstream audio packet to the first sink device.

Embodiments of such a method may include one or more of the following features. The method may further comprise transmitting, by the first sink device, an acknowledgement indicating that the downstream audio packet was received by the first sink device. Causing the data to be transmitted comprises transmitting, by the second sink device, an interferer packet that prevents the audio source device from properly receiving the acknowledgment. The method may further comprise transmitting, by the first sink device, a negative acknowledgement (NAK) packet.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for coordinated sniffing of packets transmitted by a source device using Bluetooth Low Energy (BLE) audio protocol. The method also includes receiving, by a first sink device, a downstream audio packet addressed to the first sink device. The method also includes sniffing, by a second sink device, the downstream audio packet addressed to the first sink device. The method also includes causing data to be transmitted to an audio source device, where the transmission of the data is timed to cause the audio source device to resend the downstream audio packet to the first sink device. The method also includes transmitting, by the audio source device, a resend of the downstream audio packet to the first sink device. Other embodiments of this aspect include corresponding computer systems, apparatus, and computer programs recorded on one or more computer storage devices, each configured to perform the actions of the methods.

Implementations may include one or more of the following features. The method may include: transmitting, by the first sink device, an acknowledgement indicating that the downstream audio packet was received by the first sink device; and where causing the data to be transmitted may include transmitting, by the second sink device, an interferer packet that prevents the audio source device from properly receiving the acknowledgment. Causing the data to be transmitted may include transmitting, by the first sink device, a negative acknowledgement (NAK) packet. The second sink device does not transmit either an acknowledgment or negative acknowledgment in response to the receiving of the downstream audio packet. The first sink device is a first earbud and the second sink device is a second earbud, the method may include: determining, by the second earbud, that the second earbud was unsuccessful in sniffing the downstream audio packet;

and where causing the data to be transmitted may include transmitting, by the second earbud, an interferer packet indicating that the downstream audio packet was not properly received by the first earbud despite the first earbud having properly received the downstream audio packet. The method may include: receiving, by the first sink device, a second downstream audio packet addressed to the first sink device; and transmitting, by the first sink device, in response to receiving the second downstream audio packet, an acknowledgment that the second downstream audio packet was properly received by the first sink device. The first sink device and the second sink device are true wireless stereo earbuds. The second downstream audio packet includes same audio data as the downstream audio packet; determining, by the second sink device, that the second downstream audio packet addressed to the first sink device was not successfully sniffed by the second sink device; and in response to determining that the second downstream audio packet was not successfully sniffed, transmitting, by the second sink device, an interferer packet timed to prevent an acknowledgment transmitted by the first earbud in response to the second downstream audio packet from being successfully received by an audio source device. Implementations of the described techniques may include hardware, a method or process, or computer software on a computer-accessible medium.

One general aspect includes a wireless earbud system that uses the Bluetooth Low Energy (BLE) audio protocol. The wireless earbud system also includes a first earbud may include: a first wireless interface, a first speaker, a first processing system, and a first microphone. The system also includes a second earbud may include: a second wireless interface, a second speaker, a second processing system, and a second microphone, where: the first earbud is not physically connected with the second earbud; the first earbud is configured to receive a downstream audio packet addressed to the first earbud; the second earbud is configured to sniff the downstream audio packet addressed to the first earbud; at least one of the first earbud, or the second earbud is configured to cause data to be transmitted to an audio source device, where the transmission of the data is timed to cause the audio source device to resend the downstream audio packet to the first earbud; and the first earbud is configured to receive a resend of the downstream audio packet addressed to the first earbud. Other embodiments of this aspect include corresponding computer systems, apparatus, and computer programs recorded on one or more computer storage devices, each configured to perform the actions of the methods.

Implementations may include one or more of the following features. The wireless earbud system where the first earbud is further configured to: transmit an acknowledgement indicating that the downstream audio packet was received by the first earbud; and the second earbud is further configured to transmit an interferer packet that prevents the audio source device from properly receiving the acknowledgment. Causing the data to be transmitted may include the first earbud transmitting a negative acknowledgement (nak) packet. The second earbud is unsuccessful sniffing the downstream audio packet; and where causing the data to be transmitted may include the second earbud transmitting an interferer packet indicating that the downstream audio packet was not properly received by the first earbud despite the first earbud having properly received the downstream audio packet. The first earbud is further configured to transmit an acknowledgment that a second downstream audio packet was properly received by the first earbud. The second earbud is configured to receive the downstream audio packet, the resend of the downstream audio packet, or both, where the second earbud does not transmit either an acknowledgment or negative acknowledgment in response to the receiving of the downstream audio packet. The earbuds are true wireless stereo earbuds. Implementations of the described techniques may include hardware, a method or process, or computer software on a computer-accessible medium.

One general aspect includes a wireless earbud that uses the Bluetooth Low Energy (BLE) audio protocol. The wireless earbud also includes a wireless interface. The earbud also includes a microphone. The earbud also includes a speaker. The earbud also includes a processing system in communication with the wireless interface, the microphone, and the speaker, where: the wireless earbud is not physically connected with a second earbud, the wireless earbud is configured to receive a downstream audio packet addressed to the wireless earbud, and the wireless earbud is configured to transmit a negative acknowledgement indicating that the downstream audio packet was not properly received despite the wireless earbud having properly received the downstream audio packet. Other embodiments of this aspect include corresponding computer systems, apparatus, and computer programs recorded on one or more computer storage devices, each configured to perform the actions of the methods.

Implementations may include one or more of the following features. The wireless earbud where the wireless earbud is further configured to transmit a second negative acknowledgement indicating that a resend of the downstream audio packet was not received by the first earbud. The wireless earbud is further configured to transmit an interferer packet indicating that a second downstream audio packet was not properly received by the second earbud despite the second earbud having properly received the downstream audio packet. The wireless earbud is further configured to sniff a second downstream audio packet addressed to the second earbud. The wireless earbud is further configured to transmit an acknowledgement that it properly received a second downstream audio packet addressed to the first earbud. Implementations of the described techniques may include hardware, a method or process, or computer software on a computer-accessible medium.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an embodiment of a system that includes earbuds communicating with an audio source.

FIGS. 2A and 2B illustrates embodiments of device-to-device packet communication between a pair of earbuds and an audio source.

FIG. 3 illustrates a method for device-to-device packet communication between a pair of earbuds and an audio source.

FIG. 4A illustrates another embodiment of device-to-device packet communication between a pair of earbuds and an audio source using NAKs to force resends of packets.

FIG. 4B illustrates an embodiment of device-to-device packet communication between a pair of earbuds and an audio source using NAKs to force resends of packets.

FIG. 4C illustrates an embodiment of device-to-device packet communication between a pair of earbuds and an audio source using NAKs to force resends of packets.

FIG. 5 illustrates an embodiment of a method for device-to-device packet communication between a pair of earbuds and an audio source.

FIG. 6 illustrates another embodiment of device-to-device packet communication between a pair of earbuds and an audio source.

### DETAILED DESCRIPTION

Techniques are described herein that are directed to coordinated sniffing of air traffic by sink devices (e.g., true wireless stereo (TWS) earbuds that may be referred to herein as “earbuds”). The techniques are directed to reducing wireless data transmission, reducing power consumption, and helping to ensure that sink devices receive the transmitted data from a source. Prior to techniques described herein, a source device transmitted duplicate data to each sync device (e.g., left and right audio to a left earbud and left and right audio to a right earbud) or used a faster data-rate physical (PHY) channel (e.g., 4 Mbits/sec instead of 2 Mbits/sec) to keep airtime occupancy constant. However, transmitting duplicate data uses double the wireless data transmission as well as consuming more power at the source device. Using a faster data-rate PHYs has more complex modulation which reduces link budgets or requires more power-hungry receivers on the sink devices. None of these arrangements may be desirable.

Embodiments detailed herein can involve one sync device (e.g., a first/second earbud) sniffing on the air traffic intended for another sync device (e.g., the second/first earbud) without awareness or coordination from the source device. Such sniffing is transparent to the source and the source needs to take no action. The arrangements detailed herein do not require a direct link between the earbuds nor direct coordination. The arrangement detailed herein further can include techniques/algorithms to cause the source to retransmit packets which were received unsuccessfully by the sniffing earbud even if they were received successfully by the intended earbud.

There are different techniques/algorithms which can be used in isolation or in some combination. A first technique that can be used in embodiments can transmit an interferer packet that prevents the source from receiving an acknowledgment packet. In these examples, assume a left earbud is receiving its own left channel in subevent1 of an isochronous interval and is sniffing the right earbud's right channel audio in subevent2 of the isochronous interval. Similarly, right earbud is receiving the right channel during subevent2 and sniffing the left channel during subevent1. In some examples, the earbuds are configured to perform bidirectional audio communication (e.g., during a phone call, video conference, audio conference, gaming session, . . . ) where audio is received wirelessly by the earbuds from an audio source (e.g., smartphone, laptop, computer, . . . ) for output via one or both speakers of the earbuds (referred to as downstream audio). Audio can also be captured using one or more microphones of the earbuds and wirelessly transmitted by the earbuds to the audio source (referred to as upstream audio). According to some examples, the earbuds use Bluetooth-based communications using Bluetooth LE Audio. While this document is focused on examples involving earbuds, embodiments are also applicable to situations where two or more wireless speakers are present.

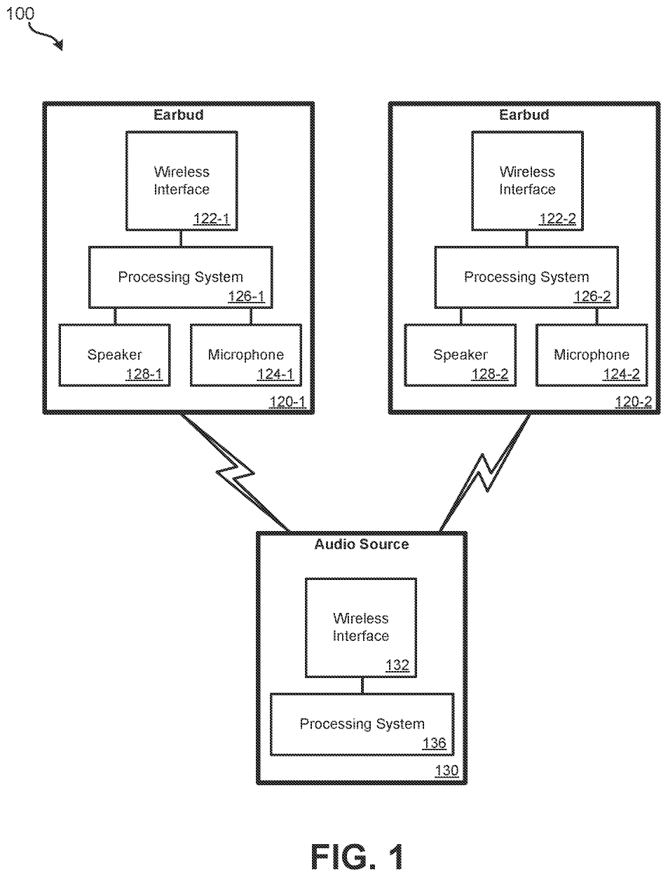

Further detail regarding such embodiments and others is provided in relation to the figures. FIG. 1 illustrates a system 100 in which bidirectional audio is transmitted between earbuds 120 and audio source 130. Downstream audio is transmitted from audio source 130 to earbuds 120 and upstream audio (e.g., voice captured via microphone) is transmitted from one of earbuds 120 to audio source 130. System 100 includes: earbud 120-1 (e.g., a right or left earbud of a pair of true wireless earbuds); earbud 120-2 (e.g., a true wireless earbud for the opposite ear from earbud 120-1); and audio source 130. Communication between earbuds 120 and audio source 130 occurs via a low-power device-to-device communication protocol, such as Bluetooth Low Energy (LE) Audio.

Earbuds 120 can be TWS earbuds, which refer to a pair of earbuds that do not have any physical connection, such as a wire or band, connecting the two earbuds or with an audio source. True wireless earbuds can allow a user to use both earbuds 120 or use a single earbud (either earbud 120-1 or earbud 120-2) at a given time.

Some components of earbuds 120 are illustrated. Specifically, earbuds 120 include: wireless interfaces 122; microphones 124; processing systems 126; and speakers 128. All components of earbuds 120 can be housed by housings of the respective earbud, which can be made from a rigid or semi-rigid material. Earbuds 120 can be shaped to be at least partially inserted into a user's ear so that it will stay in place during normal body movements.

Wireless interface 122 can be a short-range wireless interface that allows for a device-to-device exchange of data. For example, short-range refers to up to 1, 10, 15, or 20 meters. Wireless interface 122 can be a Bluetooth interface that allows for data to be exchanged according to a communication protocol from the Bluetooth family of communication protocols, such as Bluetooth basic rate or extended data rate (BR/EDR, which can also be referred to as “Bluetooth classic”), and Bluetooth Low Energy (BLE) protocol. Wireless interface 122 can communicate using the 2.4 GHz band, which for Bluetooth spans from 2.4 GHz to 2.4835 GHz. This frequency band can be divided up into a number of channels, such as 80 channels for Bluetooth BDR/EDR, each 1 MHz wide, or 40 channels for Bluetooth LE, which are each 2 MHz wide. Bluetooth communications can involve frequent channel changes within the 2.4 GHz band, such as up to 1600 channel changes per second.

Wireless interfaces 122 can be understood as Bluetooth wireless interfaces in that each of wireless interfaces 122 can communicate with other Bluetooth interfaces (e.g., wireless interface 132) that conform to the Bluetooth standard. For example, in FIG. 1, audio source 130 has a Bluetooth interface, referred to as wireless interface 132. Wireless interfaces 122 can exchange data using Bluetooth protocols with wireless interface 132. For example, wireless interface 132 may be used to transmit downstream audio packets to wireless interfaces 122 while upstream audio packets constructed using audio captured using one or more of microphones 124 are transmitted by wireless interfaces 122 to wireless interface 132.

In earbud 120-1, processing system 126-1 can be in communication with wireless interface 122-1; speaker 128-1; and microphone 124-1. In earbud 120-2, processing system 126-2 can be in communication with wireless interface 122-2; speaker 128-2; and microphone 124-2. Processing systems 126 may include one or more special-purpose or general-purpose processors. Such special-purpose processors may include processors that are specifically designed to perform the functions of the components detailed herein. Such special-purpose processors may be ASICs or FPGAs which are general-purpose components that are physically and electrically configured to perform the functions detailed herein. Such general-purpose processors may execute special-purpose software that is stored using one or more non-transitory processor-readable mediums, such as flash memory or other forms of memory.

Speakers 128 are used for outputting audio to a user. Processing system 126 can control the volume of audio received via wireless interfaces 122, the gain of microphones 124, and perform other actions. Microphones 124 are present in each of earbuds 120. Microphones 124 can be used to capture audio in the vicinity of earbuds 120, such as speech of a user wearing at least one of earbuds 120 and transmit the captured audio as upstream audio packets via Bluetooth (e.g., Bluetooth LE Audio) to audio source 130. Microphones 124 can also be used to capture audio to perform noise cancellation.

In the embodiments detailed herein, a single earbud may capture and stream upstream audio to audio source 130. Earbuds 120 may decide among themselves which earbud is to transmit upstream audio. For instance, the decision as to which earbud is to transmit upstream audio may be based on battery charge in each earbud, signal strength between each earbud and audio source 130, and/or an amount of noise detected by each earbud on captured audio. In some embodiments, the audio captured by each of microphones 124 is combined to create an upstream audio stream that is transmitted to audio source 130. A particular earbud of earbuds 120 may be a “primary” earbud that determines which earbud is to transmit upstream audio according to such factors. Alternatively, the earbuds may communicate with each other to make a collective decision as to which earbud should transmit upstream audio. In some embodiments, a predefined ordering of which earbud should transmit upstream audio is used. For example, if earbud 120-1 is active, earbud 120-1 may always be given preference for transmitting upstream audio over earbud 120-2. In some embodiments, audio source 130 can select which earbud (nominally) is to send back upstream audio.

Audio source 130 includes wireless interface 132 and processing system 136. Examples of audio source 130 can include: a smartphone; a desktop, laptop, or tablet computer; a gaming device; a smart television; a digital music player device; a smartwatch; smart glasses; an augmented reality or a virtual reality headset; or any other device from which a user may desire to stream audio to earbuds 120 and, possibly, transmit upstream audio from earbuds 120 to audio source 130. Audio source 130 includes wireless interface 132, which can communicate with earbuds 120 using device-to-device communication protocols, such as a Bluetooth communication protocol (e.g., Bluetooth classic, Bluetooth LE, . . . ). Therefore, audio source 130 can transmit a downstream audio stream to one or more of earbuds 120 via wireless interface 132 and can receive an upstream audio stream from one or more of earbuds 120.

Processing system 136 may include one or more special-purpose or general-purpose processors. Such special-purpose processors may include processors that are specifically designed to perform the functions of the components detailed herein, such as detailed in relation to processing systems 126.

In the embodiments that follow, transfers of packets between earbuds and an audio source are described. In Bluetooth LE and Bluetooth LE Audio, multiple streams are active between devices. A first stream is a continuous isochronous stream (CIS) and the second stream is the asynchronous connectionless link (ACL). While the CIS is used to transmit media packets (e.g., audio packets), the ACL is used to transmit management and control data (e.g., time-related anchoring information for the CIS channel, or a volume adjustment command). Typically, each CIS has an associated ACL. In various embodiments, multiple CIS and ACL pairs may be present, such as for different pieces of audio that playing simultaneously. While the embodiments detailed below illustrate sniffing for CIS, sniffing can also be done for ACL. Therefore, the arrangement and techniques detailed below can be applied in part or in whole to both types of links.

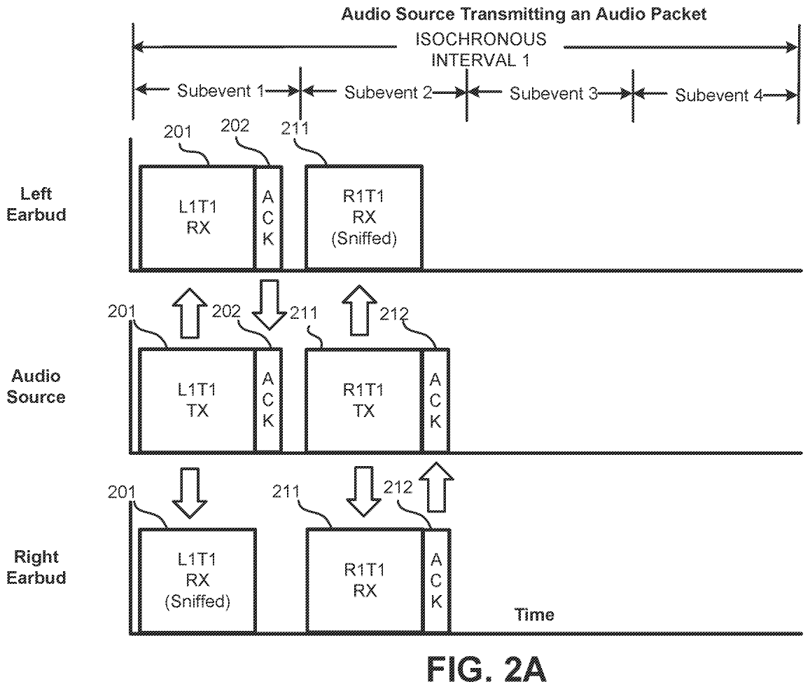

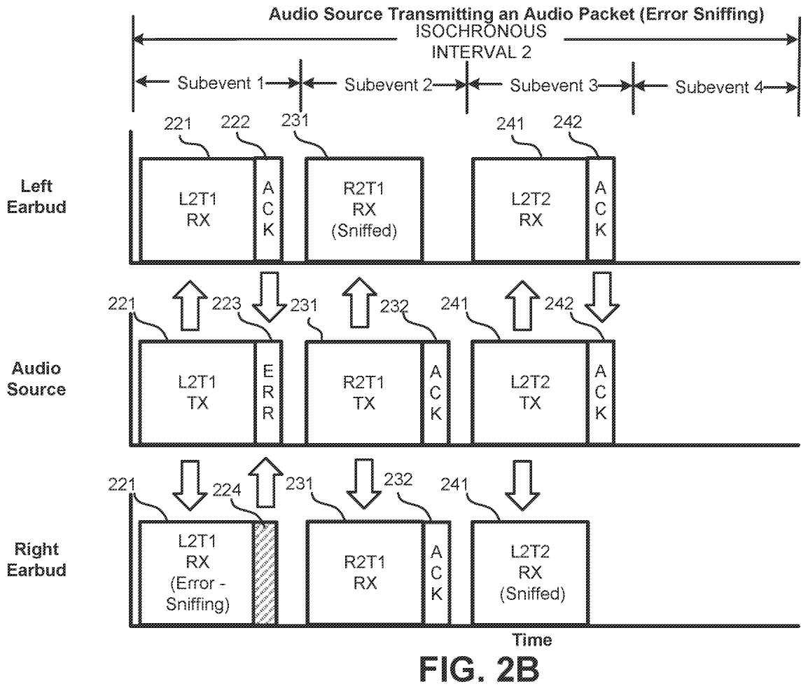

FIGS. 2A and 2B illustrate embodiments of device-to-device packet communication between a pair of earbuds and an audio source. In the example of FIGS. 2A and 2B, the earbuds and the audio source can be communicating using isochronous channels of Bluetooth LE Audio. The earbuds and the audio source can also be configured to use two downstream isochronous channels of audio (with both channels containing the same audio information and one downstream channel from the audio source to each of the earbuds) and a single upstream isochronous channel for data from the earbuds to the audio source. In this example, the upstream audio channel is expected by the audio source to be received from the left earbud. The earbuds and the audio source can also be configured to use one downstream isochronous channel (containing either 1 channel of audio or multiple channels of audio encoded separately and arranged sequentially or encoded jointly) to only one earbud, with the source unaware of the other earbud (but the other earbud nonetheless having an effect on how the source interacts with the earbud that the source is aware of).

As illustrated, separate subevents are shown within an isochronous interval of Bluetooth LE Audio communications. During a first subevent (Subevent 1) downstream audio packet 201, which is labeled as L1T1, is a first packet addressed to the left earbud (L1) and this is the first attempt (T1) at sending by the audio source. Packet 201 is transmitted by the audio source (TX) and is received (RX) by the left earbud. The right earbud may sniff packet 20 (e.g., using an encryption key of the left earbud).

In response to properly received packet 201, the left earbud transmits acknowledgment 202 to the audio source. Packet 201 may be used by the left earbud for creating an audio signal that is output via a speaker of the left earbud. With acknowledgement 202, the left earbud can transmit an upstream data packet (not shown).

During Subevent 2 downstream audio packet 211, which is labeled as R1T1, is a first packet addressed to the right earbud (R1) and is the first try (T1). Packet 211 is transmitted by the audio source (TX) and is received by the right earbud, labeled (RX). The left earbud may sniff packet 211. Acknowledgement 212 is sent by the right earbud to indicate that packet 211 was properly received. Acknowledgement 212 is received by the audio source, which indicates to the audio source to stop further transmission attempts of the packet. Packet 211 is used by the right earbud for creating an audio signal that is output via a speaker of the right earbud.

As shown in FIG. 2A, during isochronous interval 1, subevent 1, left earbud ACKs as is normal during subevent1 because it received L1T1 (left channel audio, 1st packet, 1st send) successfully, and the right earbud does not ACK even though it sniffed L1T1 successfully. Similarly, during subevent2, right earbud ACKs as is normal because it received R1T1 (right channel audio, 1st packet, 1st send) successfully, but the left earbud does not ACK even though it sniffed R1T1 successfully. This represents normal error-free operation.

However, as shown in FIG. 2B, cases where there may an error for the sends of the left and/or right audio packets may need to be handled. As illustrated, during isochronous interval 2, left earbud transmits an ACK 222 as is normal during subevent 1 because it received packet 221 successfully, however, right earbud got an error while sniffing. In some embodiments, right earbud can send out an interfering packet 224 that corrupts the audio source's reception of the left earbud's ACK 222, causing the audio source to mark packet 221 as an unsuccessful send.

An interferer packet, such as interferer packet 224, serves the purpose of causing another packet to fail to be properly received—that is, it interferes with proper reception. An example of a low-complexity interfering packet may just be all 0's, all 1's, or an alternating pattern of 1's and 0's for a duration of a 40 bit-period starting within 8 to 16 bits of the expected start time of the packet to be blocked from reception (other patterns or pseudo-random arrangements of 1's and 0's are also possible). Generally, any data that causes the audio source to not acknowledge the ACK 222 can be used.

The corruption of ACK 222 by the interferer packet 224 causes the audio source to schedule a resend of L2T1 as L2T2 (2nd packet, 2nd send) for subevent 3 of the isochronous interval. During subevent 3, both earbuds decode L2T2 successfully and only the left earbud sends an ACK back to the source, in the same manner as for subevent 1 during isochronous interval 1. Because right earbud is silent, the left earbud's ACK is received successfully by source and the source marks L2 as sent successfully and won't schedule subsequent resends.

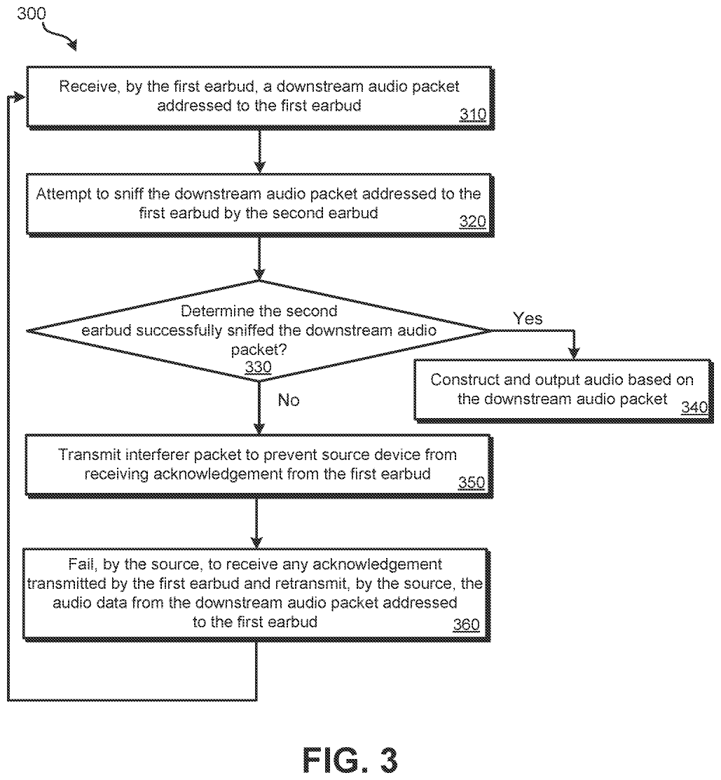

Various methods may be performed using the systems, states, and arrangements detailed in relation to FIGS. 1-2, 4A-4C, and 6. FIG. 3 illustrates a method that may be performed when a second earbud has missed a downstream audio packet. At block 310, the source device may transmit, and the first earbud/sink device may receive, a downstream audio packet. In response to receiving the downstream audio packet at block 310, the first earbud may transmit an acknowledgement. In some examples, if the downstream audio packet at block 310 is not successfully received by the first earbud, the first earbud would instead transmit a negative acknowledgement.

At block 320, concurrently with block 310, the second earbud/sink device attempts to sniff the downstream audio packet addressed to the first earbud. If the second earbud determines it successfully sniffed the downstream audio packet at block 320, the downstream audio packet can be used to construct and output audio at 340 by the second earbud and no acknowledgment, negative acknowledgment, or interferer packet is sent by the second earbud. The first earbud may transmit a negative acknowledgement if it did not receive the packet properly and, thus, and a resend would occur, but could be ignored by the second earbud.

However, if the second earbud determines it did not successfully receive/sniff the downstream audio packet, it proceeds to block 350 at which an interferer packet or signal is transmitted to be at the same time or any portion of the time during which the first earbud transmits its acknowledgement or negative acknowledgement for the received downstream audio packet of block 310. The interferer packet causes any acknowledgement transmitted by the first earbud to not be successfully received by the audio source device. In response, the source device retransmits the same audio data again in a retry of the downstream audio packet at block 360. Following block 360, method 300 may repeat up to some permissible number of times. In some examples, the permissible number of times may be limited by a flush timeout of the source device, the second earbud successfully sniffing the downstream audio packet, or a predefined maximum number of permitted interferer packets maintained by the earbuds.

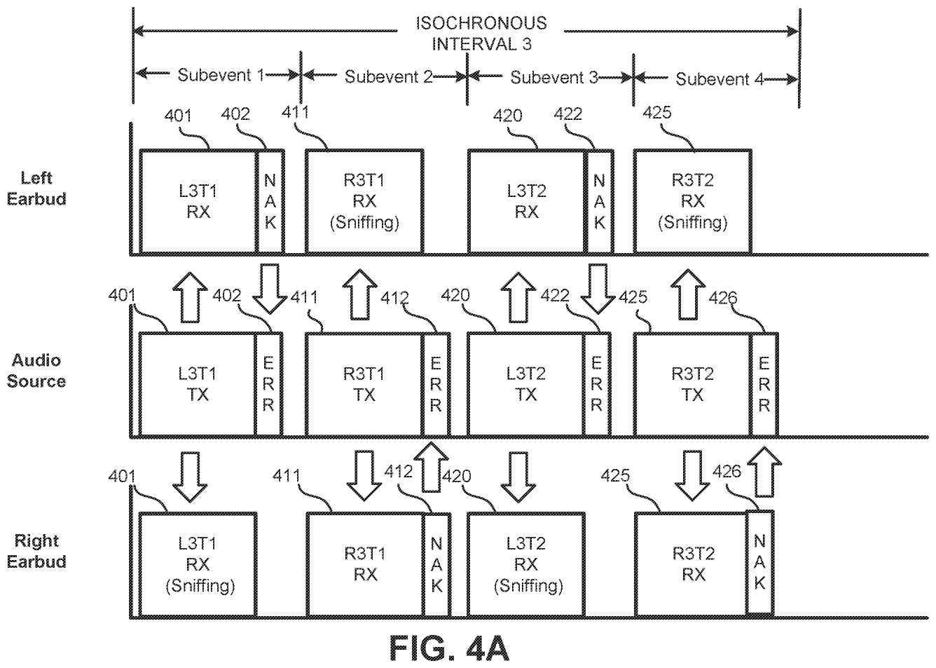

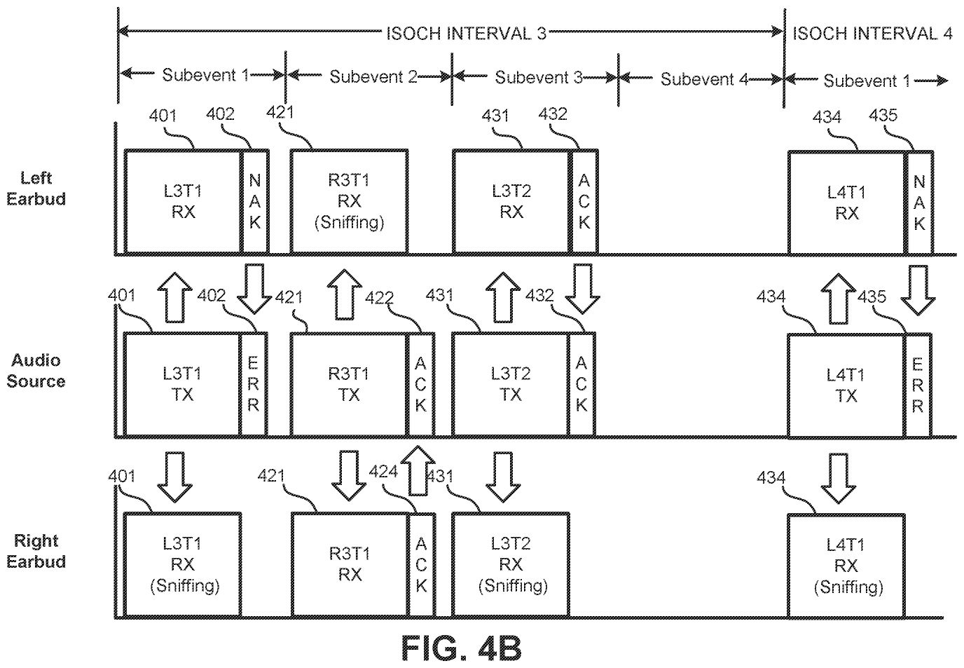

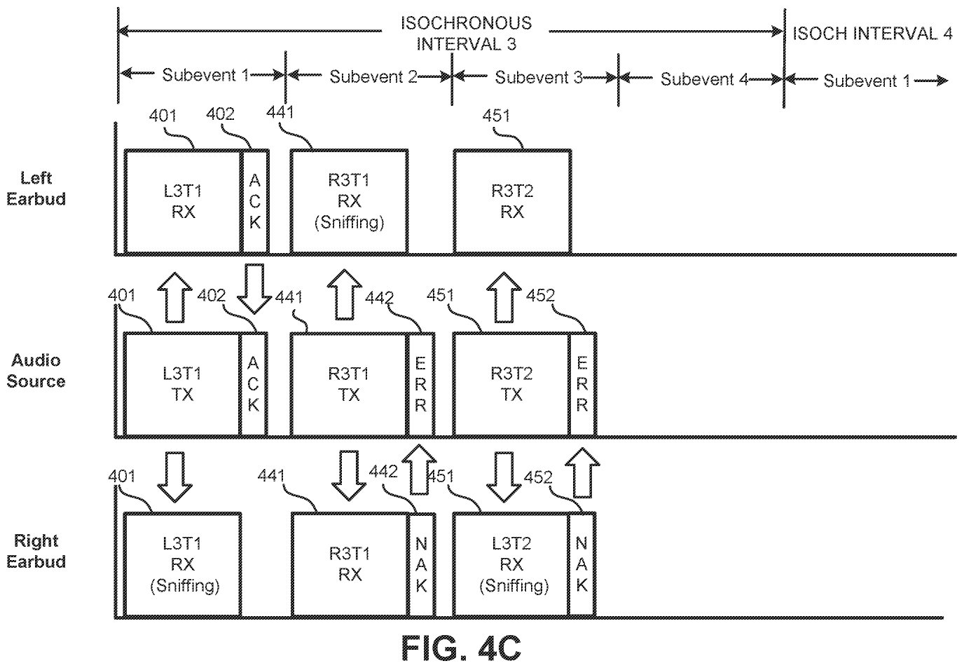

FIG. 4A represents an embodiment of audio packets being sent, such as via LE Audio, to each earbud by a source device using a persistent NAK technique. As an example, FIG. 4A can represent an audio listening session. Packet 401, which in this example is a first attempt of a third packet addressed to the left earbud, that can be successfully sniffed, or unsuccessfully sniffed, by the right earbud. In some examples, negative acknowledgement 402 is sent by the left earbud to the audio source regardless of whether the right earbud successfully sniffed the packet 401. According to some configurations, the left earbud and/or the right earbud sends a predefined number of negative acknowledgements (e.g., 1, 2, 3, . . . ) such that the left earbud and/or the right earbud has an increased number of opportunities to sniff the packet sent to the other earbud.

In response to negative acknowledgement 402, the source device sends the packet 420 in subevent 3 that contains the same audio data as packet 401. In this example, NAK 422 is transmitted to indicate that packet 420 was not properly received by the left earbud (even though it may have been properly received). While packet 420 is transmitted by the audio source to the left earbud, the right earbud attempts to sniff the packet (for a second time).

FIG. 4A also shows the source device sending the packet 411 in subevent 2 to the right earbud. In some configurations, NAK 412 is transmitted to indicate that packet 411 was not properly received by the right earbud (even though it may have been properly received). While packet 411 is transmitted by the audio source to the right earbud, the left earbud attempts to sniff the packet (for a second time). In other examples, the right earbud and/or the left earbud may not be configured to automatically NAK one or more times (See FIG. 4B and FIG. 4C). In response to negative acknowledgement 412, the source device sends the packet 425 in subevent 4, which contains the same audio data as packet 411. While packet 425 is transmitted by the audio source to the right earbud, the left earbud attempts to sniff the packet (for a second time).

In FIG. 4A, only two attempts at sending the “L3” packet and the “R3” packet are shown. In other embodiments, the total number of attempts can be greater or fewer. In yet other examples, the earbud that is sniffing the packet sent to the other earbud may transmit an interferer packet (not shown) one or more times thereby causing the source device to resend the respective packet.

The interferer may be a special packet (or signal) that is timed to coincide with when the other earbud transmits an acknowledgement, or a negative acknowledgement at the same time. As discussed above, the purpose of the interferer packet is to cause an acknowledgement to not be properly received by the source device. Instead, the source device receives a corrupted packet, which is a combination of interferer packet and ACK/NAK. Since the acknowledgement is not properly received by the source device, the source device treats the corrupted data as a negative acknowledgement and schedules a resend.

It is also possible that if packet 401, or packet 420 was not properly received by the left earbud, the left earbud is permitted to send one or more additional NAKs to cause the source device to send a third or greater retry of the data of packets 401 and 420. For instance, NAKs may be permitted to be sent such that the data of the packet is sent at least three, four, or more times. In some embodiments, the limiting factor may be the flush timeout (FT) of the source device or a predefined number of permissible packets maintained by the earbuds.

FIG. 4B represents an embodiment of audio packets being sent, such as via LE Audio, to each earbud by a source device using a persistent NAK technique. In examples of using the persistent NAK technique, at least one earbud always NAKs on at least the first send from the source. According to some configurations, whether the earbud NAKs on a resend from source depends on whether the earbud determines that the other earbud was able to sniff the packet (e.g., received an “OK” message from the other earbud). In the example of FIG. 4B, the left earbud is configured to automatically NAK on at least the first packet 401 received by the left earbud.

In some examples, one of the earbuds may not be transmitting its own acknowledgements (ACKs) or negative acknowledgements (NAKs). As such, an earbud does not know whether downstream audio packets to be used to create audio by the other earbud were properly received by the other earbud. To increase the odds that the other earbud properly receives the packet, the earbud can always cause some number of retries of each downstream packet addressed to the earbud. For example, two, three, four, or some maximum permissible number of retries within the isochronous interval may be triggered to be sent by the source device by the earbud sending negative acknowledgements.

As illustrated in FIG. 4B, downstream audio packet 401 is transmitted by the source device in subevent 1 and is addressed to the left earbud. Packet 401 may or may not be received properly by the left earbud. Regardless of whether it is received properly, the left earbud is configured to transmit a negative acknowledgement 402. Packet 401, if properly received, however, can be used by the left earbud to create and output audio via its speaker. Packet 401 is attempted to be sniffed by the right earbud. In response to properly receiving packet 421, the right earbud transmits acknowledgement 424. Acknowledgement 424 is received by the audio source and allows the audio source to not retransmit the data of packet 421.

Audio source retransmits the data of packet 401 as packet 431 in response to the NAK 402. In the current example, packet 431 is (properly) received (via sniffing) by the right earbud. In response to receiving packet 431, in some examples, the right earbud may send a message to the left earbud indicating that it successfully received packet 431. In other examples, the right earbud does not communicate with the left earbud. While only one NAK is automatically transmitted in the current example, the greater the number of transmission attempts by the source device, the greater the likelihood that the data within the packet will be received properly at least once by the right earbud. The number of retries triggered by an earbud can be predefined, such as one, two, three, four, or some maximum permissible number of retries that can be fit within an isochronous interval.

FIG. 4C represents an embodiment of audio packets being sent, such as via LE Audio, to each earbud by a source device using a persistent NAK technique. FIG. 4C is similar to FIG. 4B but is from the perspective of the right earbud automatically performing at least one NAK. In the example of FIG. 4C, the right earbud is configured to automatically NAK on at least the first packet 401 received by the left earbud.

As illustrated in FIG. 4C, downstream audio packet 401 is transmitted by the source device in subevent 1 and is addressed to the left earbud. Packet 401 is received properly by the left earbud, and the left earbud transmits an acknowledgement 402. The left earbud may attempt to sniff the packet 401.

Downstream audio packet 441 is transmitted by the source device in subevent 2 and is addressed to the right earbud. Packet 4401 may/may not be received properly by the right earbud, and the right earbud transmits a NAK 442. The left earbud may attempt to sniff the packet 441. Packet 441, if properly received, however, can be used by the right earbud to create and output audio via its speaker. Packet 441 is attempted to be sniffed by the left earbud.

Audio source retransmits the data of packet 441 as packet 451 in response to the NAK 442. In the current example, packet 441 may/may not be (properly) received by the right earbud. In response to receiving packet 451, the right earbud may send a NAK 452 to the audio source. While two NAKs are automatically transmitted in the current example of FIG. 4C, more or fewer NAKs may be configured. Generally, the greater the number of transmission attempts by the source device, the greater the likelihood that the data within the packet will be received properly at least once by the right earbud. The number of retries triggered by an earbud can be predefined, such as one, two, three, four, or some maximum permissible number of retries that can be fit within an isochronous interval. While the previous diagrams refer to “left” and “right” earbuds, it should be understood that the roles may be reversed. Therefore, for example, the left earbud can be understood as either a first or second earbud, while the right earbud can be understood as the remaining second or first earbud.

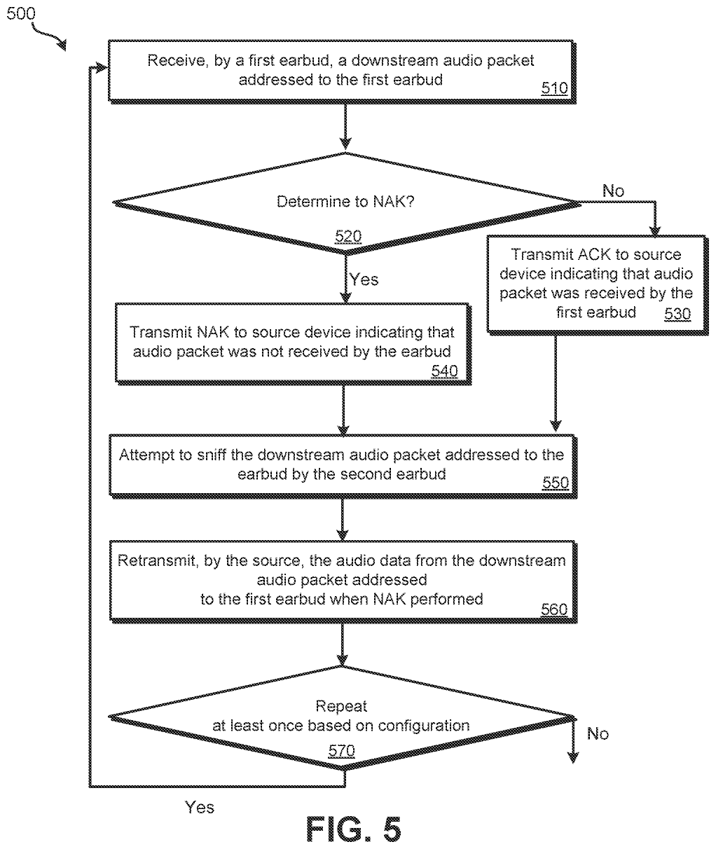

FIG. 5 illustrates an embodiment of a method 500 of device-to-device packet communication between a pair of earbuds and an audio source using a NAK technique. Method 500 refers to at least two earbuds. Either a left or right earbud can function as the first earbud and the other earbud functions as the second earbud. In method 500, different configurations can be used (e.g., Bluetooth LE Audio Configuration C that specifies two downstream audio channels (one to each earbud) and one upstream audio channel from an earbud to the audio source).

At block 510, a first earbud receives a downstream audio packet that is addressed to the first earbud. The first earbud may or may not receive the packet.

At block 520, a determination is made as to whether to automatically NAK upon receipt of the packet. Regardless of whether the first earbud receives the packet, the first earbud transmits a NAK in response back to the audio source for at least one transmission. In this way, the second earbud has at least two chances to sniff the audio packet.

At block 530, when the first earbud is not automatically providing a NAK (e.g., after already performing a NAK a predetermined number of times), the first earbud transmits an ACK to the source device indicating that the packet was properly received.

At block 540, the first earbud transmits a NAK regardless of whether the packet was

properly received.

At block 550, substantially contemporaneously to block 510, the second earbud attempts to sniff the audio packet from the audio source that is addressed to the first earbud. As this reception is performed via sniffing, the second earbud may have access to one or more encryption keys that would be used by the first earbud for receiving and transmitting encrypted data. This same packet transmitted by the audio source may (or may not) be received by the second earbud at block 550. If successfully received by the second earbud, the second earbud can use the audio data from the packet to output audio via the second earbud's speaker. Regardless of whether the packet is received or not by the second earbud, the second earbud does not transmit an acknowledgement or a negative acknowledgement.

At block 560 if a negative acknowledgement transmitted at block 550 is received by the audio source and triggers the audio source to retransmit the downstream audio packet of block 510 addressed to the first earbud. The downstream audio packet can then be resent by the audio source, thus giving the second earbud at least one additional opportunity to receive the downstream audio packet. This resend increases the likelihood that the second earbud will have received the downstream audio packet on the first try, the second try, or both. If received on the first try, subsequent receptions of the same packet may be discarded or ignored. Regardless, no acknowledgement or negative acknowledgement is sent by the second earbud.

Block 570 indicates that blocks 510-560 may repeat multiple times. The number of times which these blocks repeat can be based on how many retries the earbuds are configured to force. In some embodiments, the maximum number of retries within an isochronous interval are used to maximize the likelihood that the downstream packet gets received by the second earbud. If a predefined number of repeats is used, at block 570, once the number of repeats is met, the first earbud may send an acknowledgement rather than a negative acknowledgement to allow the audio source to refrain from further resends of the downstream audio packet. Following block 570, method 500 may return to block 510 for a next downstream audio packet that is being sent to the second earbud.

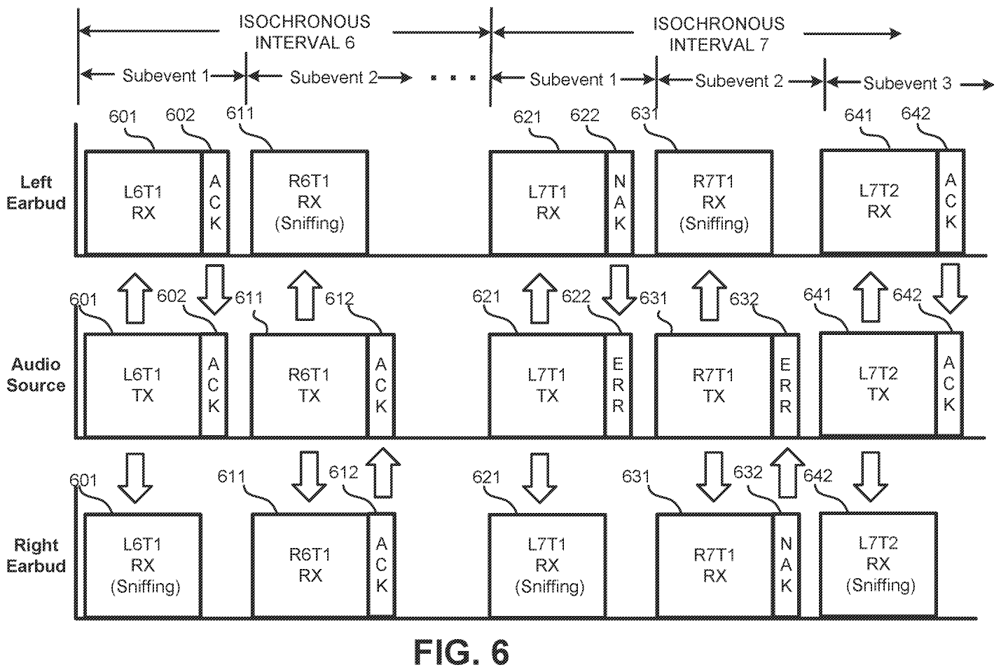

FIG. 6 represents an embodiment of audio packets being sent, such as via LE Audio, to each earbud by a source device using a dynamic NAK technique. As an example, FIG. 6 can represent an audio listening session.

In the dynamic NAK technique, a determination is made as to how many resends the earbuds force based on conditions associated with the source and earbuds. In some examples, this determination is dynamic and based on information such as past, current, and/or predicted RF channel conditions (e.g., determined from accumulated error statics), location data (whether the user is in known location with predictable conditions or is jogging outdoors), a number of other devices using BLE near the earbuds, and/or other sources of information. The number can be changed lower or higher, with different attack and decay rates, and even in anticipatory fashion. The number can be communicated directly between the two earbuds or relayed through source and can be different for each earbud.

According to some examples, the left earbud, right earbud, and/or the audio source are configured to determine/detect conditions that can affect transmission/receipt of packets. For example, one or more of the earbuds can detect that the signal between the earbuds and audio source is below a specified level (or has been experiencing errors exceeding a predefined level), and in response set the number of resends to a specified number. The determination can be made periodically (e.g., every minute, ten minutes, . . . ), or upon the occurrence of the event (e.g., based upon a change of location such as inside to outside, . . . ).

In the example illustrated by FIG. 6, the initial detection of the conditions indicated that a good connection exists and that no automatic NAKs are to be sent. As such, packet 601, which in this example is a first attempt of a sixth packet addressed to the left earbud, is transmitted by the audio source to the left earbud. Acknowledgement 602 is sent by the left earbud to the audio source. The right earbud can also sniff the packet 601. Similarly, in this example, the audio source transmits packet 611 to the right earbud. Acknowledgement 612 is transmitted from the right earbud to the audio source. The left earbud can also sniff packet 611.

Moving to isochronous interval 7, the conditions were detected by the left earbud, right earbud, and/or the audio source. In the current example, the determined/detected conditions have indicated slightly deteriorated conditions, and the number of retransmissions is set to one. As such, packet 621 is transmitted by the audio source to the left earbud. NAK 622 is sent by the left earbud to the audio source regardless of whether the left earbud received packet 621. The right earbud can also sniff the packet 621. Similarly, in this example, the audio source transmits packet 631 to the right earbud. NAK 632 is transmitted from the right earbud to the audio source. The left earbud can also sniff packet 631. Since NAK 622 was sent by the left earbud, the audio source retransmits packet 641 to the left earbud which provides an acknowledgement 642 to the audio source. The number of forced retransmissions can continue to be updated and set as time progresses (e.g., periodically and/or updated in response to changed conditions). While not shown, the audio source also retransmits packet 631 since a NAK was received from the right earbud.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known, processes, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

1. A method for coordinated sniffing of packets transmitted by a source device using Bluetooth Low Energy (BLE) Audio protocol, the method comprising:
receiving, by a first sink device, a downstream audio packet addressed to the first sink device;
sniffing, by a second sink device, the downstream audio packet addressed to the first sink device;
causing data to be transmitted to an audio source device, wherein the transmission of the data is timed to cause the audio source device to resend the downstream audio packet to the first sink device; and
transmitting, by the audio source device, a resend of the downstream audio packet to the first sink device.

2. The method of claim 1, further comprising:
transmitting, by the first sink device, an acknowledgement indicating that the downstream audio packet was received by the first sink device; and
wherein causing the data to be transmitted comprises transmitting, by the second sink device, an interferer packet that prevents the audio source device from properly receiving the acknowledgment.

3. The method of claim 1, wherein causing the data to be transmitted comprises transmitting, by the first sink device, a negative acknowledgement (NAK) packet.

4. The method of claim 1, wherein the first sink device is a first earbud and the second sink device is a second earbud, the method further comprising:
determining, by the second earbud, that the second earbud was unsuccessful in sniffing the downstream audio packet; and
wherein causing the data to be transmitted comprises transmitting, by the second earbud, an interferer packet indicating that the downstream audio packet was not properly received by the first earbud despite the first earbud having properly received the downstream audio packet.

5. The method of claim 1, further comprising:
receiving, by the first sink device, a second downstream audio packet addressed to the first sink device; and
transmitting, by the first sink device, in response to receiving the second downstream audio packet, an acknowledgment that the second downstream audio packet was properly received by the first sink device.

6. The method of claim 3, further comprising receiving, by the second sink device, the downstream audio packet, the resend of the downstream audio packet, or both, wherein the second sink device does not transmit either an acknowledgment or negative acknowledgment in response to the receiving of the downstream audio packet.

7. The method of claim 1, wherein the first sink device and the second sink device are true wireless stereo earbuds.

8. The method of claim 1, further comprising:
receiving, by the first sink device, a second downstream audio packet addressed to the first sink device, wherein the second downstream audio packet includes same audio data as the downstream audio packet;
determining, by the second sink device, that the second downstream audio packet addressed to the first sink device was not successfully sniffed by the second sink device; and
in response to determining that the second downstream audio packet was not successfully sniffed, transmitting, by the second sink device, an interferer packet timed to prevent an acknowledgment transmitted by the first earbud in response to the second downstream audio packet from being successfully received by an audio source device.

9. A wireless earbud system that uses the Bluetooth Low Energy (BLE) Audio protocol, comprising:
a first earbud comprising: a first wireless interface, a first speaker, a first processing system, and a first microphone; and
a second earbud comprising: a second wireless interface, a second speaker, a second processing system, and a second microphone, wherein:
the first earbud is not physically connected with the second earbud;
the first earbud is configured to receive a downstream audio packet addressed to the first earbud;
the second earbud is configured to sniff the downstream audio packet addressed to the first earbud;
at least one of the first earbud, or the second earbud is configured to cause data to be transmitted to an audio source device, wherein the transmission of the data is timed to cause the audio source device to resend the downstream audio packet to the first earbud; and
the first earbud is configured to receive a resend of the downstream audio packet addressed to the first earbud.

10. The wireless earbud system of claim 9, wherein the first earbud is further configured to:
transmit an acknowledgement indicating that the downstream audio packet was received by the first earbud; and
the second earbud is further configured to transmit an interferer packet that prevents the audio source device from properly receiving the acknowledgment.

11. The wireless earbud system of claim 9, wherein causing the data to be transmitted comprises the first earbud transmitting a negative acknowledgement (NAK) packet.

12. The wireless earbud system of claim 9, wherein the second earbud is unsuccessful sniffing the downstream audio packet; and
wherein causing the data to be transmitted comprises the second earbud transmitting an interferer packet indicating that the downstream audio packet was not properly received by the first earbud despite the first earbud having properly received the downstream audio packet.

13. The wireless earbud system of claim 9, wherein the first earbud is further configured to transmit an acknowledgment that a second downstream audio packet was properly received by the first earbud.

14. The wireless earbud system of claim 9, wherein the second earbud is configured to receive the downstream audio packet, the resend of the downstream audio packet, or both, wherein the second earbud does not transmit either an acknowledgment or negative acknowledgment in response to the receiving of the downstream audio packet.

15. The wireless earbud system of claim 9, wherein the earbuds are true wireless stereo earbuds.

16. A wireless earbud that uses the Bluetooth Low Energy (BLE) Audio protocol, comprising:
a wireless interface;
a microphone; and
a speaker; and
a processing system in communication with the wireless interface, the microphone, and the speaker, wherein:
the wireless earbud is not physically connected with a second earbud;
the wireless earbud is configured to receive a downstream audio packet addressed to the wireless earbud; and
the wireless earbud is configured to transmit a negative acknowledgement indicating that the downstream audio packet was not properly received despite the wireless earbud having properly received the downstream audio packet.

17. The wireless earbud of claim 16, wherein the wireless earbud is further configured to transmit a second negative acknowledgement indicating that a resend of the downstream audio packet was not received by the wireless earbud.

18. The wireless earbud of claim 16, wherein the wireless earbud is further configured to transmit an interferer packet indicating that a second downstream audio packet was not properly received by the second earbud despite the second earbud having properly received the downstream audio packet.

19. The wireless earbud of claim 16, wherein the wireless earbud is further configured to sniff a second downstream audio packet addressed to the second earbud.

20. The wireless earbud of claim 16, wherein the wireless earbud is further configured to transmit an acknowledgement that it properly received a second downstream audio packet addressed to the wireless earbud.
